(19) United States
(12) Patent Application Publication
(10) Pub. No.: US 2004/0047152 A1
(43) Pub. Date: Mar. 11, 2004

(54) Portable illuminator for use with a laptop computer

(76) Inventors: Kuo-Jung Hung, Taipei City (TW); Wei-Yuan Ho, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/237,134

(22) Filed: Sep. 9, 2002

(51) Int. Cl. F21V 11/00

(52) U.S. Cl. 362/240; 362/438; 362/198; 362/171; 362/488; 362/508; 362/545; 362/800

(57) ABSTRACT

A portable illuminator includes a transmission element with a resilient core received inside the transmission element so that the transmission element is able to be bent to any shape, a connector securely formed on a first distal end of the transmission element and having a connection portion formed with the connector for connection to a power source, and an illuminating unit formed on a second distal end of the transmission element and having therein a housing with a light emitting diode received in a compartment defined in the housing. The connection of the connection portion of the connector to the power source is able to provide electricity to the illuminating unit so that with the resilience of the transmission element, the light emitting diode is able to light an area required.

### BACKGROUND OF THE INVENTION

1. Field of the Invention

The present invention relates to a portable illuminator, and more particularly to a portable illuminator for use with a laptop computer. The portable illuminator has a transmission element, a plug securely coupled to one distal end of the transmission element and an illuminating device coupled to the other distal end of the transmission element. A clip is provided on the transmission element so that the illuminator is able to attach to a side face of the screen of a laptop computer.

2. Description of Related Art

A conventional keyboard illuminator generally has a plain board removably attached to a computer keyboard, a control panel mounted on one side of the plain board and at least one illuminator electrically mounted on the control panel. The illuminator has an arm rotatably connected to the control panel and a light bulb rotatably connected to a distal end of the arm. Therefore, the illuminator is able to rotate around the keyboard via the arm and the light bulb is also rotatable relative to the arm so that the user is able to adjust the light bulb and the arm to an angle where the best lighting effect is gained.

Although the foregoing conventional illuminator is able to provide sufficient light to the user, the illuminator is suitable for the desktop computer because this type of illuminator occupies a large space and is not portable. Further, although the light bulb and the arm are rotatable, the plain board is not able to be folded to minimize the size of the illuminator. Even after the light bulb and the arm are rotated to reduce the overall size of the illuminator, the illuminator is still bulky for portable use.

Therefore, during a briefing or a presentation, should the user bring along an illuminator of this size for use with a laptop computer, the user will need help from others to manage to place all the devices in place, which is quite awkward and unpractical.

To overcome the shortcomings, the present invention tends to provide an improved portable illuminator to mitigate and obviate the aforementioned problems.

### SUMMARY OF THE INVENTION

The primary objective of the present invention is to provide an improved portable illuminator suitable for a laptop computer. Another objective of the present invention is to provide an improved portable illuminator having a programmable circuit board received in a housing and connected to a light emitting diode so that the blinking manner is able to be controlled to show status of the laptop computer.

In order to accomplish the foregoing objective, the portable illuminator includes a transmission element for transmission power, a connector securely connected to a first distal end of the transmission element and having a connection portion for engaging with a power source and an illuminating unit detachably connected to a second distal end of the transmission element and having a light emitting diode received in a housing. With the foregoing parts, the user is able to bend the transmission element to any desired angle so that the light emitting diode is able to light the effective area. Other objects, advantages and novel features of the invention will become more apparent from the following detailed description when taken in conjunction with the accompanying drawings.

### BRIEF DESCRIPTION OF THE DRAWINGS

FIG. 1 is a perspective view of the preferred embodiment of the present invention;

FIG. 2 is an exploded perspective view of the portable illuminator in FIG. 1;

FIG. 3 is a perspective view of the application of the portable illuminator;

FIG. 4 is a perspective view of the clip clamped to a side face of a laptop computer so as to hold the illuminating unit;

FIG. 5a is an exploded perspective view of the illuminating unit of the second preferred embodiment;

FIG. 5b is a perspective view of the illuminating unit in FIG. 5a;

FIG. 6 is a perspective view of the third preferred embodiment of the present invention;

FIG. 7 is a perspective view of the fourth preferred embodiment of the present invention;

FIG. 8 is a perspective view of the fifth preferred embodiment of the present invention; and

FIG. 9 is a perspective view of the sixth preferred embodiment of the present invention

### DETAILED DESCRIPTION OF THE PREFERRED EMBODIMENT

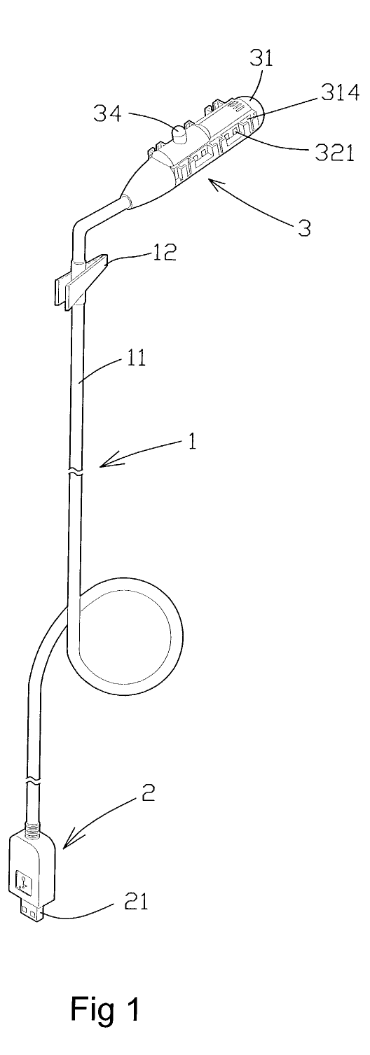

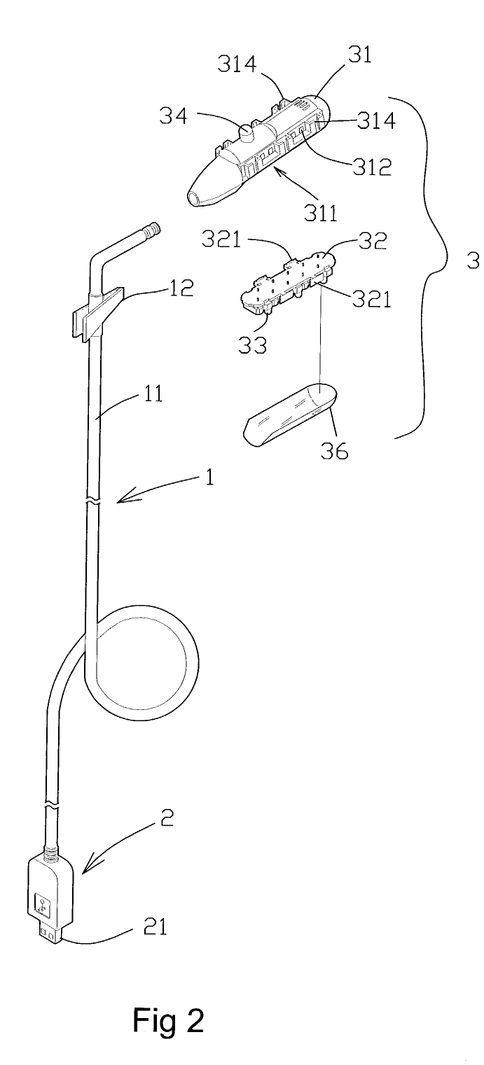

With reference to FIGS. 1 and 2, the portable illuminator in accordance with the present invention has a transmission element 1 with a resilient core 11 received inside the transmission element 1 and a clip 12 securely provided on the transmission element 1, a connector 2 securely connected to a first distal end of the transmission element 1 and a illuminating unit 3 detachably connected to a second distal end of the transmission element 1.

With the resilient core 11 received in the transmission element 1, the transmission element 1 is able to be bent to any shape and angle.

The connector 2 has a connection portion 21 integrally formed with the connector 2 for engaging with a power source. The connection portion 21 may be a USB (Universal Series Bus) connector or a 1394 (data bus) connector.

The illuminating unit 3 is detachably connected to a second distal end of the transmission element 1 and includes a housing 31 with a compartment 311 defined in the housing 31 and a circuit board 32 received in the compartment 311 and provided with a light emitting diode (LED) 33. A button 34 is mounted on the housing 31 to control the activation of the LED 33 and an enclosure 36 is partially provided outside the housing 31 to cover the location where the compartment 311 is defined. It is noted that the LED 33 and the enclosure 36 may have colors according to the situations as designed. Multiple holes 3 12 are defined in at least one side of the housing 3 1 and recesses 314 are defined close to the holes 312 in the housing 31. The circuit board 32 has contacts 321 corresponding to the holes 312 so that after the circuit board 32 is received in the compartment 311, the contacts 321 are received in the corresponding holes 312.

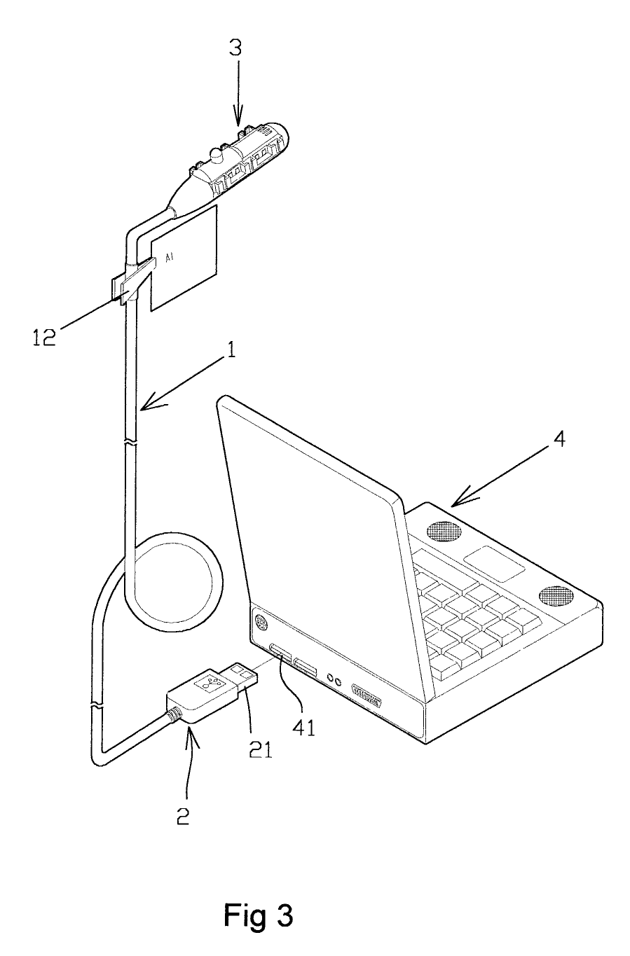

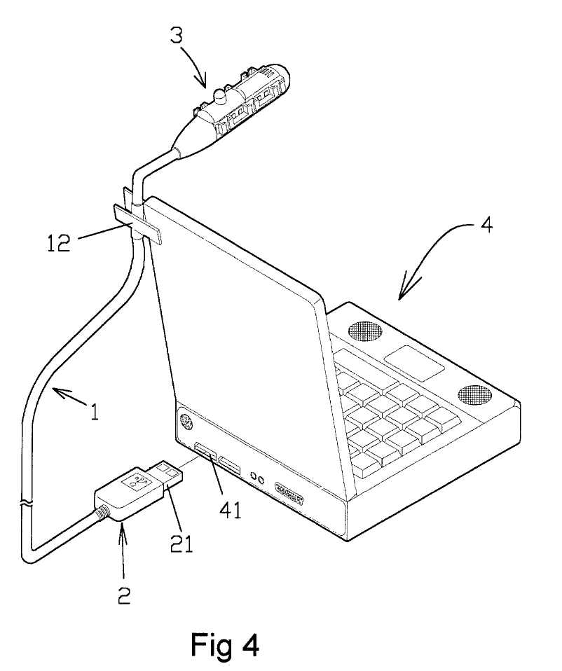

With reference to FIGS. 3 and 4, after the enclosure 36 is mounted outside the housing 31 to cover the circuit board 32, the connection portion 21 is directly connected to a power output port 41 of a laptop computer 4. The user is able to push the button 34 on the housing 31 to activate the LED 33. Because the portable illuminator of the present invention is connected to the laptop computer 4 for power so that even when there is a power failure from the power plant, the portable illuminator can still operate properly. Furthermore, the circuit board 32 is programmable so that the user is able to design a certain blinking patter of the LED 33 so that when there is an incoming email transmission or an incoming call, the LED 33 is able to remind the user of the incoming incident. Still, the user is able to use the clip 12 to hold a piece of paper on a side of the illuminating unit 3 so that the user is able to use the light of the LED 33 to read the information on the paper.

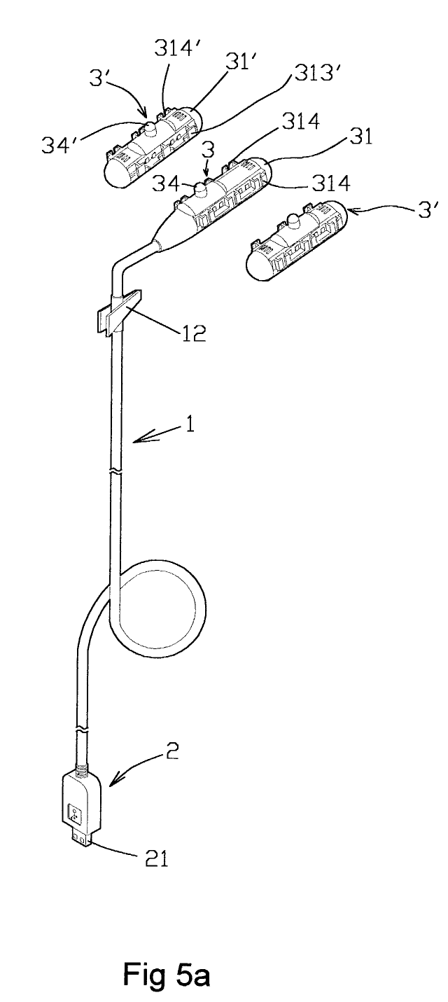

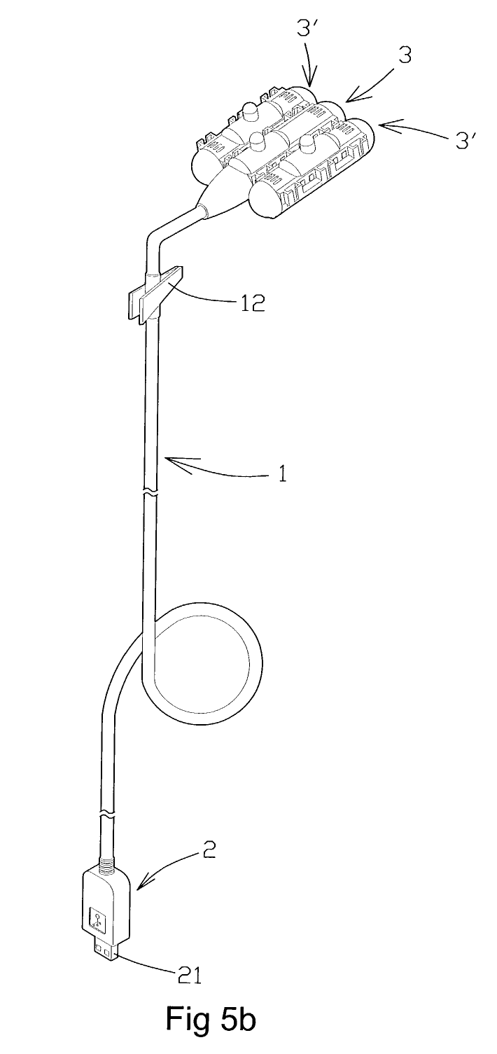

With reference to FIGS. 5a and 5b, a secondary illuminating unit 3′ may be provided to the illuminating unit 3. The secondary illuminating unit 3′ has a button 34′ independent from the button 34, ears 313′ formed on one side of the housing 31′ and guiding recesses 314′ defined in the other side of the housing 31′. Contacts 321′ are provided inside the housing 31′ to correspond to the contacts 32. When the secondary illuminating unit 3′ is to be combined with the illuminating unit 3, each of the ears 313′ are inserted into a corresponding one of the recesses 314 to allow engagement between the contacts 321 and the contacts 321′. Thus power is supplied to the secondary illuminating unit 3′. Furthermore, it is noted that two secondary illuminating units 3′ may be provided to both sides of the illuminating unit 3 with the ears 313′ inserted into corresponding recesses 314 to allow engagement between the contacts 321 and the contacts 321′.

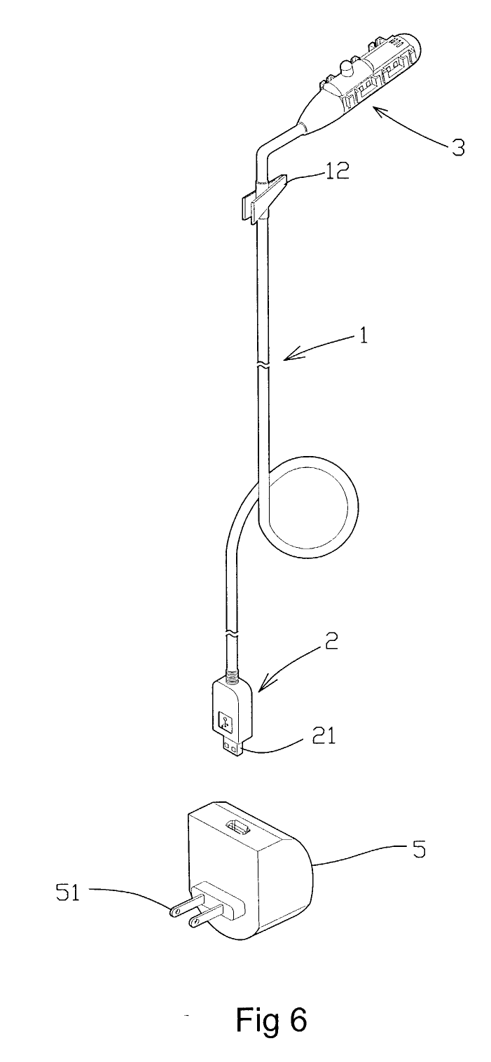

With reference to FIG. 6, the connection portion 21 of the connector 2 is able to connect to an adapter 5 that has two contact pins 51 available to electrically connect to a wall outlet so as to provide electricity to the illuminating unit 3.

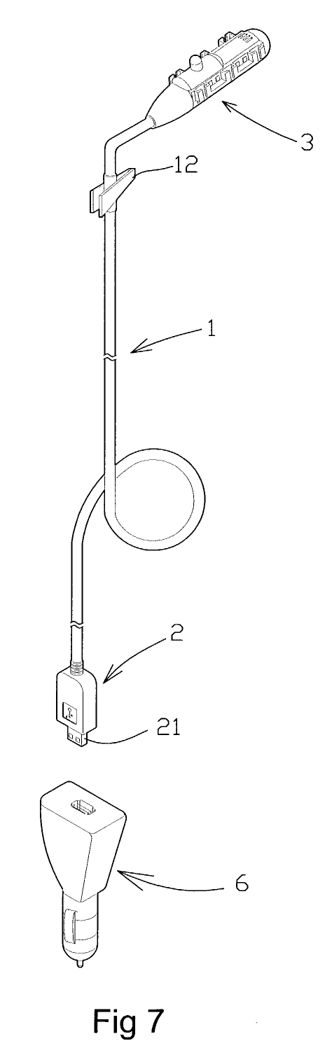

With reference to FIG. 7, the connection portion 21 of the connector 2 is able to connect to a cigarette lighter 6 on a vehicle. The cigarette lighter 6 is able to be plugged in a socket in the vehicle so that the illuminating unit 3 is able to have electricity to light the LED 33.

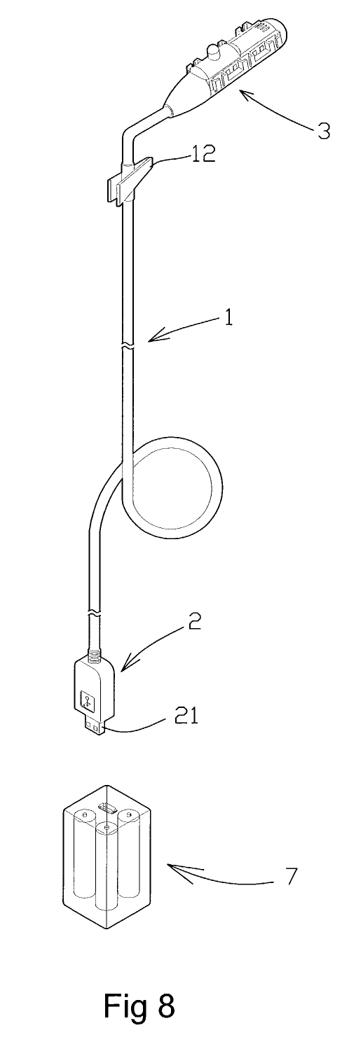

With reference to FIG. 8, the connection portion 21 of the connector 2 is able to connect to a battery box 7 so that the illuminating unit 3 has power to light the LED 33.

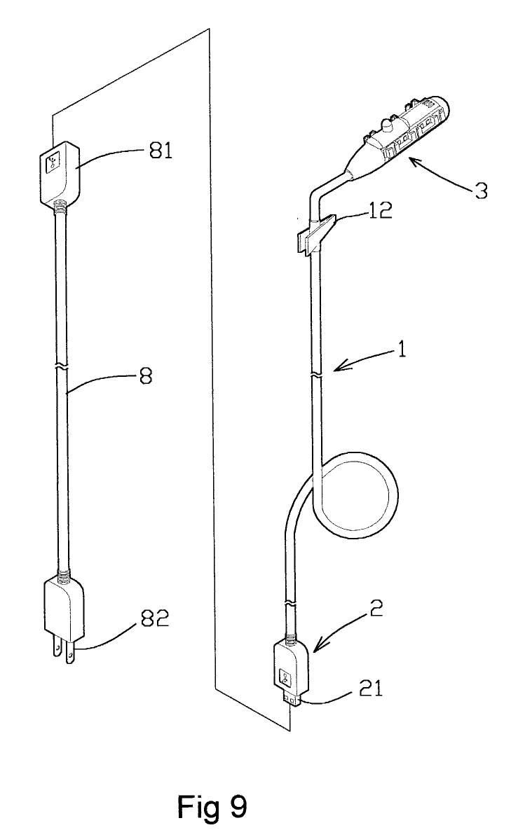

With reference to FIG. 9, the connection portion 21 of the connector 2 is able to connect to an extension wire 8 having an adapter 81 on one end of the extension wire 8 to be connected to the connection portion 21 and a plug 82 on the other end of the extension wire 8 to be connected to a wall outlet so that the illuminating unit 3 is able to have electricity to light the LED 33.

It is noted that the LED 33 may not be formed on the circuit board 32 and is able to connect to the circuit board 32 via a wire (not shown). The contacts 321 may also be formed on one side of the housing 31 to electrically connect to the circuit board 32. With such an arrangement, the illuminating unit 3 still has the power to light the LED 33.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable illuminator for use with a laptop computer, the portable illuminator comprising:
a transmission element with a resilient core received inside the transmission element so that the transmission element is able to be bent to any shape;
a connector securely formed on a first distal end of the transmission element and having a connection portion formed with the connector for connection to a power source; and
an illuminating unit formed on a second distal end of the transmission element and having therein a housing with a light emitting diode received in a compartment defined in the housing,
whereby the connection of the connection portion of the connector to the power source is able to provide electricity to the illuminating unit so that with the resilience of the transmission element, the light emitting diode is able to light an area required.

2. The portable illuminator as claimed in claim 1, wherein the connector is a universal series bus.

3. The portable illuminator as claimed in claim 1, wherein the connector is a data bus.

4. The portable illuminator as claimed in claim 1, wherein the connector is connected to a plug for connection to a wall outlet.

5. The portable illuminator as claimed in claim 1, wherein the connector is connected to a cigarette lighter for connection with a power source on a vehicle.

6. The portable illuminator as claimed in claim 1, wherein the connector is connected to a battery box so that the illuminating unit is able to have electricity from the battery box.

7. The portable illuminator as claimed in claim 1, wherein the connection portion of the connector is connected to an extension wire with a plug formed on a free end of the extension wire so that the extension wire is able to connect to a wall outlet to provide electricity to the illuminating unit.

8. The portable illuminator as claimed in claim 1 further comprising a enclosure made of a translucent material to cover the compartment.

9. The portable illuminator as claimed in claim 1, wherein the housing has therein a circuit board and a button formed on housing to electrically connect to the circuit board.

10. The portable illuminator as claimed in claim 1, wherein the housing has holes on at least one side of the housing and recesses defined close to the holes, the circuit board has contacts formed to be received in the holes.

11. The portable illuminator as claimed in claim 10 further comprising a secondary illuminating unit having therein a housing with ears formed to correspond to the recesses and contacts to electrically contact with the illuminating unit so that the secondary illuminating unit is able to have electricity from the illuminating unit.
